(19) United States
(12) Patent Application Publication
(10) Pub. No.: US 2012/0024037 A1
(43) Pub. Date: Feb. 2, 2012

(54) COMPACT PROVERS

(75) Inventor: Glenn Christopher Massey, Wotton-under-Edge (GB)

(73) Assignee: ALDERLEY PLC, Wotton-under-Edge, Gloucestershire (GB)

(21) Appl. No.: 13/260,465

(22) PCT Filed: Mar. 24, 2010
(86) PCT No.: PCT/GB2010/000515

§ 371 Date: Sep. 26, 2011

(30) Foreign Application Priority Data
Mar. 26, 2009 (GB) 0905174.9

(51) Int. Cl. G01F 25/00

(52) U.S. Cl. 73/1.19

(57) ABSTRACT

A compact prover assembly (10) suitable for determining the accuracy of a flow meter. The assembly (10) includes a piston (20) and cylinder arrangement (12) with a cylinder (14) with an inlet (16) and an outlet (18) towards respective ends thereof. The arrangement (12) also includes a piston (20) movable by fluid flowing through the inlet (16) towards the outlet (18), and means for measuring the time taken for the piston (20) to move between predetermined points in the cylinder (14). The piston (20) includes a flow past arrangement, which includes an opening (28) and a cover (34). The cover (34) is selectively movable substantially parallel to the piston between a closed position closing the opening (28), and an open position clear of the opening (28) to permit fluid to pass through the opening (28) and hence through the piston (20) when the piston (20) is static or being moved backwards towards the inlet (16).

This invention concerns improvements in or relating to compact prover assemblies.

Compact provers are used to determine the accuracy of flowmeters, and particularly turbine, ultrasonic, coriolis and positive displacement flowmeters. Conventionally compact provers include a piston and cylinder, with fluid flowing into the cylinder moving the piston between two predetermined points. A flow computer measures the length of time taken for the piston to move between these points. The computer may also calculate any expansion in the cylinder circumference due to the internal pressure and temperature, and compensate for this. The resulting measured flow rate is verified by further piston runs to obtain a measured time within a small tolerance of repeatability.

After the piston has moved between the two predetermined points it is necessary to move the piston back to beyond the first of the predetermined points to enable a further measurement to be carried out. Whilst the piston is being moved back it is necessary for fluid to be able to move therepast. Conventionally poppet valves have been provided on the pistons which can be opened to allow fluid to pass through the pistons. The closing of the poppet valves however causes pressure fluctuations within the cylinder which is undesirable.

According to the present invention there is provided a compact prover assembly, the assembly comprising a piston and cylinder arrangement, the piston and cylinder arrangement including a cylinder inlet and a cylinder outlet each towards a respective end of the cylinder, a piston movable by fluid flowing through the inlet towards the outlet, means for measuring the time taken for the piston to move between predetermined points in the cylinder, the piston including a flow past arrangement, which flow past arrangement includes an opening and a cover, which cover is selectively movable substantially parallel to the piston between a closed position closing the opening, and an open position clear of the opening to permit fluid to pass through the opening and hence through the piston when the piston is being moved backwards towards the inlet.

The opening may be provided in a first part of the piston, with the cover provided in a second part of the piston.

An opening may be provided in the second part of the piston, alignable with the opening in the first part, when the cover is in the open position.

A plurality of openings may be provided in the first part, and a corresponding number of openings may be provided in the second part. The first and second parts may be rotatably movable relative to each other.

The first and second parts may be in the form of coaxially mounted discs.

An actuator may be provided for moving the cover between the open and closed positions. The actuator may be in the form of a piston and cylinder. The piston and cylinder may be engageable between actuation members respectively connected to the first and second parts of the piston.

The assembly may be arranged such that in a failure condition of the actuator the second part moves to or remains in the open position.

The assembly may be arranged such that the second part is automatically moved to an open condition when the piston is being moved back towards the inlet.

An embodiment of the present invention will now be described by way of example only, with reference to the accompanying drawings, in which:—

FIG. 1 is a diagrammatic cross sectional side view of a compact prover assembly according to the invention, sharing different conditions of use of the assembly;

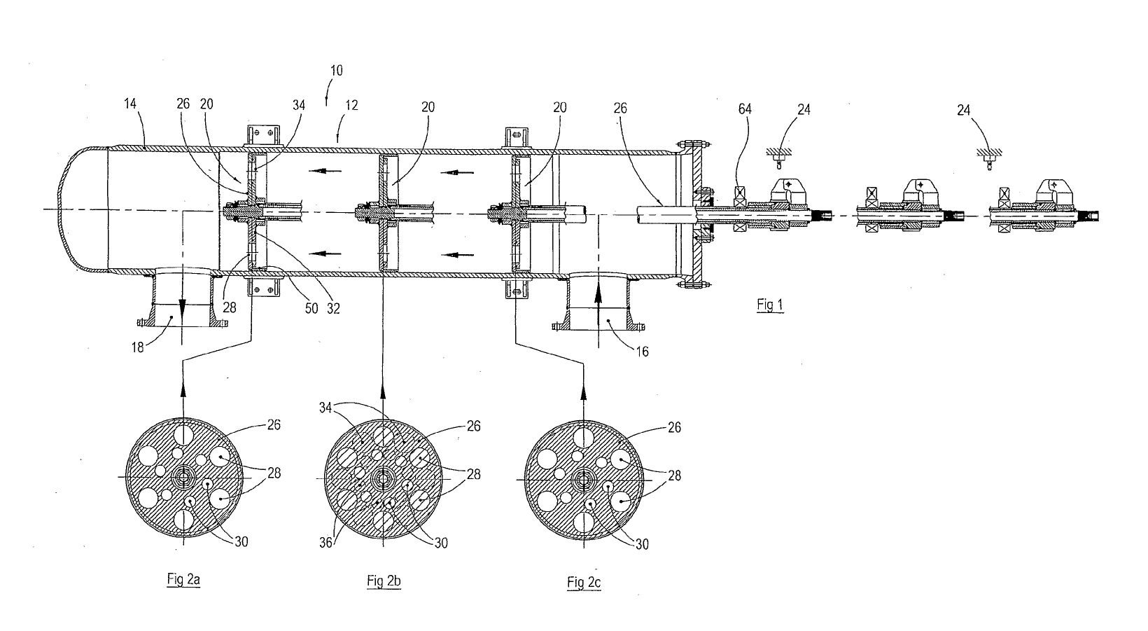

FIGS. 2a, 2b and 2c are diagrammatic end views of parts of the assembly of FIG. 1 in different conditions of use;

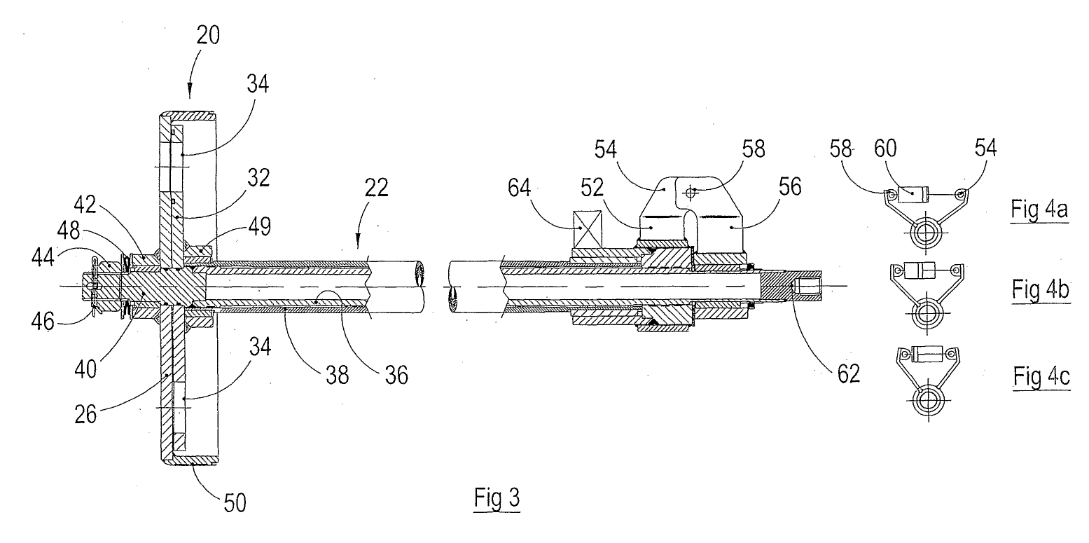

FIG. 3 is a diagrammatic cross sectional side view through part of the assembly of FIG. 1; and

FIGS. 4a, 4b and 4c are diagrammatic rear end views of part of the assembly shown in FIG. 3 in different conditions of use.

The drawings show a compact prover assembly 10 suitable for determining the accuracy of a flow meter. The assembly 10 includes a piston 20 and cylinder arrangement 12. The arrangement 12 includes a cylinder 14 with an inlet 16 and outlet 18 towards respective ends of the cylinder 14. The cylinder 14 locates a piston 20 mounted on a piston rod 22.

Spaced sensors 24 are provided outside of the cylinder 14 adjacent to the piston rod 22, and are interconnected so as to measure the time taken for the piston rod 22 and hence piston 20 to move a predetermined distance. The time taken for the piston 20 to move the predetermined distance is accurately measured, and any expansion in the cylinder circumference due to internal pressure and temperature is measured and used as compensation in respect of this time. This process is repeated on a number of occasions, and the data collated.

The piston 20 includes a flow part arrangement provided by a disc 26 which forms the front (left hand side in FIG. 1) face of the piston 20. The disc 26 has a ring of six equally spaced outer circular holes 28 and six smaller equally spaced circular holes 30. A second disc 32 is located immediately to the right as shown in FIG. 1 of the first disc 26 and is coaxially rotatable relative thereto. The second disc also includes an outer spaced ring of circular holes 34 and inner circular holes 36 in a similar configuration to the holes in the first disc 26.

The first and second discs 26, 32 are mounted to the piston rod 22. The piston rod 22 has inner and outer parts 36, 38 which are freely rotatable relative to each other. The inner part 36 is mounted at the left hand end to a profiled block 40 around which the second disc 32 is freely rotatable. To the left of the first disc 26 as shown, an outer sleeve 42 is provided which connects the first disc 26 to the inner part 36.

At the far end of the profiled block 40 an annular end member 44 is provided and held in position by a split pin 46. A spring washer is provided between the end member 44, and the outer sleeve 42 to urge the first and second discs 26, 32 against each other. The outer part 38 of the piston rod 22 is connected to the second disc 32 by a sleeve 49 to cause rotation thereof. An annular circumferential seal 50 extends around the first disc 26, which is sealingly engageable with the inside of the cylinder 14.

An outer engagement member 52 extends radially from the outer part 38 of the piston rod 22 to permit rotation thereof. The outer engagement member 52 has a rearwardly extending finger 54. An inner engagement member 56 is mounted to the right hand end of the inner part 36 of the piston rod 22, which extends beyond the right hand end of the outer part 38, to permit rotation of the inner part 36. The inner engagement member 56 has a radially extending part and a forward facing finger 58. The fingers 54, 58 are circumferentially offset so as to define a gap therebetween. A piston and cylinder actuator 60 extends between the fingers 54 and 58.

A connection point 62 is provided at the right hand end of the piston rod 22 to permit connection to line means or otherwise for moving the piston 20 to the right as shown following a time recordal movement of the piston 20. A flag member 64 is provided on the left hand end of the outer engagement member 52, which member 64 breaks a beam from either of the sensors 24 to be detected thereby as the member 64 moves past one of the sensors 24. The beam could be, for example, a laser, light, or magnetic beam.

In use, it is required to measure the time for the piston 20 to be moved by fluid flowing through the cylinder 14 to the left from the position shown in FIG. 2c, with the inner and outer engagement members 52, 56 in the position shown in the right hand most view as shown in FIG. 1, to the position shown in FIG. 2a. Initially the actuator 60 is at rest with the engagement members 52, 56 closer together as shown in FIG. 4c. In this position the respective holes 28, 34 and 30, 36 are aligned as shown in FIG. 2c, and fluid entering through the inlet 16 can pass through the piston 20 and back out through the outlet 18.

To measure the accuracy of the flow meter the actuator 60 is operated to move through the position shown in FIG. 4b to the position shown in FIG. 4a. In this instance the respective holes 28, 34 and 30, 36 are unaligned such that the discs 26, 32 provide a solid barrier to fluid entering through the inlet 16, as shown in FIG. 2b. The fluid will move the piston 20 through the position 2b to the position 2a, with the sensors 24 detecting the flag member 64 and hence the time taken for the piston 20 to move the predetermined distance.

Once in the position FIG. 2a the actuator 60 can be deactivated to return to the condition shown in FIG. 4c which will cause the disc 32 to rotate relative to the disc 26 to bring the holes 28, 34 and 30, 36 back into alignment with each other. The piston 20 can then be moved back to the position shown in FIG. 2c, with the aligned holes permitting fluid to pass therethrough.

There is thus described a compact prover assembly, and particularly a piston for a compact prover, which provides significant advantages in providing a solid piston for use when proving a meter, but which readily permits fluid to pass therethrough when being moved back to a rest condition, or when in a rest condition. In contrast to poppet valves, there is no increase in pressure and thus no pressure spike produced when the piston is moving between conditions. The arrangement is though of relatively straightforward construction and can thus provide accurate and long term operation.

Various modifications may be made without departing from the scope of the invention. For instance the two parts of the piston may be differently formed and need not be made of two discs. A different arrangement of openings could be provided.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A compact prover assembly, the assembly comprising a piston and cylinder arrangement, the piston and cylinder arrangement including a cylinder inlet and a cylinder outlet each towards a respective end of the cylinder, a piston movable by fluid flowing through the inlet towards the outlet, means for measuring the time taken for the piston to move between predetermined points in the cylinder, the piston including a flow past arrangement, which flow past arrangement includes an opening and a cover, which cover is selectively movable substantially parallel to the piston between a closed position closing the opening, and an open position clear of the opening to permit fluid to pass through the opening and hence through the piston when the piston is being moved backwards towards the inlet.

2. An assembly according to claim 1, in which the opening is provided in a first part of the piston, with the cover provided in the second part of the piston.

3. An assembly according to claim 2, in which an opening is provided in the second part of the piston, alignable with the opening in the first part, when the cover is in the open position.

4. An assembly according to claim 2, in which a plurality of openings is provided in the first part.

5. An assembly according to claim 4, in which a corresponding number of openings is provided in the second part.

6. An assembly according to claim 2, in which the first and second parts are rotatably movable relative to each other.

7. An assembly according to claim 2, in which the first and second parts are in the form of coaxially mounted discs.

8. An assembly according to claim 1, in which an actuator is provided for moving the cover between the open and closed positions.

9. An assembly according to claim 8, in which the actuator is in the form of a piston and cylinder.

10. An assembly according to claim 9, in which the piston and cylinder are engageable between actuation members respectively connected to the first and second parts of the piston.

11. An assembly according to claim 8, in which the assembly is arranged such that in a failure condition of the actuator the second part moves to or remains in the open position.

12. An assembly according to claim 2, in which the assembly is arranged such that the second part is automatically moved to an open condition when the piston is being moved back towards the inlet.

13-14. (canceled)
